(19) United States
(12) Patent Application Publication
(10) Pub. No.: US 2016/0007013 A1
(43) Pub. Date: Jan. 7, 2016

(54) 3D DISPLAY METHOD AND 3D DISPLAY DEVICE

(71) Applicants: BOE TECHNOLOGY GROUP CO., LTD., Beijing (CN); BEIJING BOE DISPLAY TECHNOLOGY CO., LTD., Beijing (CN)

(72) Inventors: Bin ZHANG, Beijing (CN); Liang ZHANG, Beijing (CN); Shuai HOU, Beijing (CN); Yu XIE, Beijing (CN)

(21) Appl. No.: 14/429,857

(22) PCT Filed: Jul. 10, 2014
(86) PCT No.: PCT/CN2014/081983

§ 371 Date: Mar. 20, 2015

(30) Foreign Application Priority Data
Dec. 30, 2013 (CN) 201310750330.8

(51) Int. Cl. H04N 13/04

(52) U.S. Cl. CPC H04N 13/0438; H04N 13/0497

(57) ABSTRACT

A 3D display method and a 3D display device are provided. The 3D display method comprises: decomposing one frame of picture into a left-eye picture and a right-eye picture, the left-eye picture including pixel information of a left-eye perspective picture, and the right-eye picture including pixel information of a right-eye perspective picture; decomposing the left-eye picture into continuously displayed left-eye sub-pictures, and decomposing the right-eye picture into continuously displayed right-eye sub-pictures. By decomposing one frame of picture into the left-eye sub-pictures and right-eye sub-pictures continuously displayed, each frame of the sub-picture can only display partial picture information, which reduces or eliminates the 3D crosstalk problem when the left-eye perspective picture and the right-eye perspective picture alternate, and improves the 3D display effect.

### TECHNICAL FIELD

Embodiments of the present invention relate to a 3D display method and a 3D display device.

### BACKGROUND

The three-dimensional (3D) display technology is to endow a viewer with a stereoscopy by utilizing a binocular stereoscopic vision principle, and its main principle is that, different images are received by left and right eyes of the viewer, respectively, the two images having the “binocular parallax” constitute a “stereoscopic image pair” due to a position difference produced by the pupil distance between two eyes of the viewer, and a stereoscopic effect is produced after the “stereoscopic image pair” is fused in the brain.

Currently, the 3D display technology mainly has two broad categories: a glasses type and a naked-eye type. An active shutter 3D technology belongs to the glasses type 3D display technology, also is called as a time-serial shading technology or a liquid crystal time-sharing technology, and the technology is mainly implemented by liquid crystal glasses, whose eyeglasses are two liquid crystal lenses which are respectively controlled to be turned on or off. By using a signal transmitting device, the turning on and off of the eyeglass of the 3D glasses and the switching of the left-eye and right-eye pictures of a screen are accurately synchronized. Specifically, the left-eye and the right-eye pictures will be alternately displayed on the screen; when the left-eye picture is displayed, the left-eye eyeglass is turned on, and the right-eye lens is turned off, so the viewer sees the left-eye picture with the left eye, and sees no picture with the right eye; and when the right-eye picture is displayed, the viewer sees the right-eye picture with the right eye, and sees no picture with the left eye; in this way, the left eye and the right eye respectively see the left-eye picture and the right-eye picture, so as to achieve the 3D stereoscopic effect. The above-described procedures must alternate for at least 120 times per second, so that the human eyes can see consecutive 3D pictures without flickering, so the active shutter 3D technology requires a screen refresh rate to be at least 120 Hz.

However, since the 3D display method in the prior art generally allows a continuous alternate display of the left-eye picture and the right-eye picture, due to an error of synchronization between the turning on and off of the eyeglass of the 3D glasses and the switching of the pictures, a 3D crosstalk phenomenon will occur inevitably, i.e., the left eye sees the right-eye picture or the right eye sees the left-eye picture, which affects a 3D display effect.

### SUMMARY OF THE INVENTION

Embodiments of the present invention provide a 3D display method and a 3D display device, which can reduce or eliminate the 3D crosstalk.

In one aspect, an embodiment of the present invention provides a 3D display method, the method comprising: decomposing one frame of picture into a left-eye picture and a right-eye picture, the left-eye picture including pixel information of a left-eye perspective picture, and the right-eye picture including pixel information of a right-eye perspective picture; and decomposing the left-eye picture into continuously displayed left-eye sub-pictures, and decomposing the right-eye picture into continuously displayed right-eye sub-pictures.

In another aspect, an embodiment of the present invention further provides a 3D display device, comprising: a display module, configured to continuously display left-eye sub-pictures, and then continuously display right-eye sub-pictures; or, configured to continuously display the right-eye sub-pictures, and then continuously display the left-eye sub-pictures, wherein, the left-eye sub-pictures are obtained by decomposing a left-eye picture corresponding to one frame of picture, and the right-eye sub-pictures are obtained by decomposing a right-eye picture corresponding to the one frame of picture.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 is a schematic diagram of decomposing one frame of picture into a left-eye picture and a right-eye picture according to an embodiment of the present invention;

FIG. 2 is a schematic diagram of decomposing a left-eye perspective picture according to an embodiment of the present invention;

FIG. 3 is a schematic diagram of decomposing a right-eye perspective picture according to an embodiment of the present invention; and

FIG. 4 is an overall decomposition schematic diagram of one frame of picture by using a 3D display method according to an embodiment of the present invention.

### DESCRIPTION OF THE EMBODIMENTS

In order to make objects, technical details and advantages of the embodiments of the invention apparent, the technical solutions of the embodiment will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

Hereinafter, embodiments of the present invention will be described in detail in conjunction with the accompanying drawings.

An embodiment of the present invention provides a 3D display method, comprising steps of:

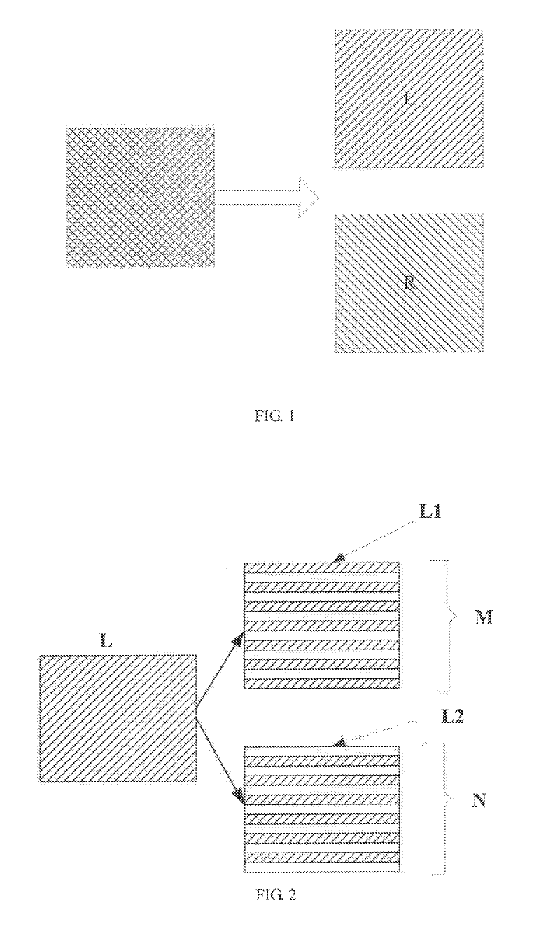

Step S1: decomposing one frame of picture into a left-eye picture and a right-eye picture, the left-eye picture including pixel information of a left-eye perspective picture, and the right-eye picture including pixel information of a right-eye perspective picture, as shown in FIG. 1.

Step S2: decomposing the left-eye picture into continuously displayed left-eye sub-pictures, and decomposing the right-eye picture into continuously displayed right-eye sub-pictures.

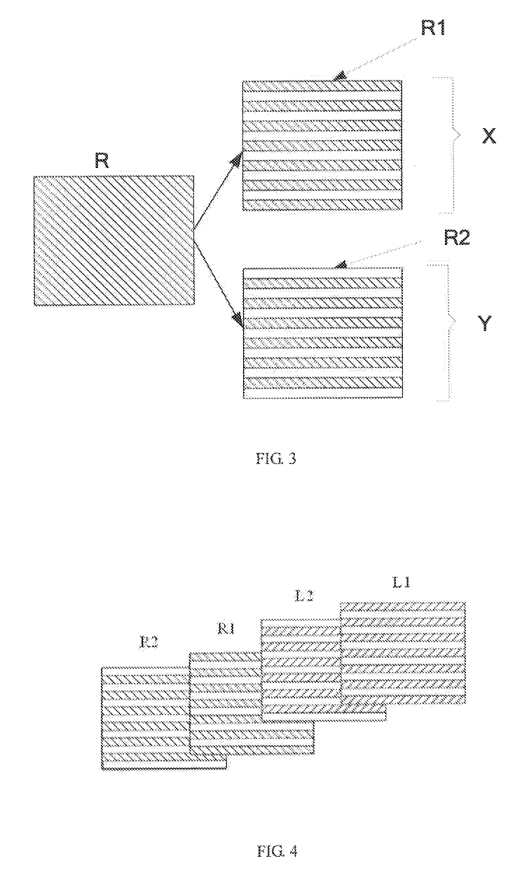

Exemplarily, the continuously displayed left-eye sub-pictures are obtained by decomposing the left-eye picture into M left-sub odd group signal frames and N left-sub even group signal frames continuously displayed, that is, the continuously displayed left-eye sub-pictures correspond to the M left-sub odd group signal frames and the N left-sub even group signal frames continuously displayed, as shown in FIG. 2; the continuously displayed right-eye sub-pictures are obtained by decomposing the right-eye picture into X right-sub odd group signal frames and Y right-sub even group signal frames, that is, the continuously displayed right-eye sub-pictures correspond to the X right-sub odd group signal frames and the Y right-sub even group signal frames continuously displayed, as shown in FIG. 3.

Exemplarily, each of M, N, X and Y is an integer greater than 1.

Exemplarily, FIG. 4 shows an overall decomposition schematic diagram of one frame of picture after the above-described steps are completed.

In the 3D display method according to an embodiment of the present invention, the left-eye picture and the right-eye picture of one frame of picture are respectively decomposed into the continuously displayed left-eye sub-pictures and the continuously displayed right-eye sub-pictures; exemplarily, the left-eye picture is decomposed into the M left-sub odd group signal frames and the N left-sub even group signal frames, and the right-eye picture is decomposed into the X right-sub odd group signal frames and the Y right-sub even group signal frames, so that each frame of the sub-picture can only display partial picture information, which solves the 3D crosstalk problem when the left-eye perspective picture and the right-eye perspective picture alternate, and improves the 3D display effect.

Exemplarily, N and M may be equal; or X and Y may be equal; or M, N, X and Y all may be equal.

In order that the pictures form a continuous image in human eyes, when the left-eye sub-pictures and the right-eye sub-pictures are respectively and continuously displayed, a sum of display time of the left-eye sub-pictures may be set to be no greater than vision persistence time of the human eyes; and a sum of display time of the right-eye sub-pictures may also be set to be no greater than the vision persistence time of the human eyes. Here, a visual persistence phenomenon of the human eyes allows the continuously displayed pictures to form a continuous image in the human eyes; exemplarily, the vision persistence time of the human eyes is less than or equal to 0.02 seconds, so in order to form the continuous image, it is necessary to display the pictures at a speed of at least 50 frames per second, i.e., the maximum persistence time of each frame of picture is 0.02 seconds, and in an embodiment of the present invention, in order that the left-eye picture and the right-eye picture are synthesized into a 3D picture, the sum of display time of the left-eye sub-pictures and the sum of display time of the right-eye sub-pictures may be less than or equal to 0.02 seconds.

In order to achieve a better anti-crosstalk effect, a transition picture needs to be inserted after the left-eye sub-pictures are continuously displayed and before the right-eye sub-pictures continue to be displayed; or the transition picture is inserted after the right-eye sub-pictures are continuously displayed, and before the left-eye sub-pictures continue to be displayed.

Further, in a process of continuously displaying the left-eye sub-pictures, the transition picture may also be inserted between each two frames of the left-sub odd group signal frames; and/or, the transition picture is inserted between each two frames of the left-sub even group signal frames. In the process of continuously displaying the left-eye sub-pictures, the transition picture may be inserted between the last frame of the left-sub odd group signal frames and the first frame of the left-sub even group signal frames; or, the transition picture may be inserted between the last frame of the left-sub even group signal frames and the first frame of the left-sub odd group signal frames.

Exemplarily, in a process of continuously displaying the right-eye sub-pictures, the transition picture may also be inserted between each two frames of the right-sub odd group signal frames; and/or, the transition picture may be inserted between each two frames of the right-sub even group signal frames. In the process of continuously displaying the right-eye sub-pictures, the transition picture may be inserted between the last frame of the right-sub odd group signal frames and the first frame of the right-sub even group signal frames; or, the transition picture may be inserted between the last frame of the right-sub even group signal frames and the first frame of the right-sub odd group signal frames.

Exemplarily, for natural transition of the transition picture which serves to prevent the crosstalk, all of the pixels of the transition picture are set as gray-scale pixels, and the gray-scale values of the pixels are all equal.

Exemplarily, in an embodiment of the present invention, the pixels may be decomposed with a row as a unit, and as shown in FIG. 2 and FIG. 3, the left-eye picture L is decomposed into M left-sub odd group signal frames L1 and N left-sub even group signal frames L2; the right picture R is decomposed into X right-sub odd group signal frames R1 and Y right-sub even group signal frames R2; wherein the M left-sub odd group signal frames include all information of the odd rows of pixels of the left-eye picture, and the N left-sub even group signal frames include pixel information of all the even-numbered rows of the left-eye picture; the X right-sub odd group signal frames include all information of the odd rows of pixels of the right-eye picture, and the Y right-sub even group signal frames include all information of the even rows of pixels of the right-eye picture.

In this case, all pixels of the even rows in each frame of the left-sub odd group signal frames, all pixels of the odd rows in each frame of the left-sub even group signal frames, all pixels of the odd rows in each frame of the right-sub even group signal frames, and all pixels of the even rows in each frame of the right-sub odd group signal frames all display random gray-scale values, which may be either the same or different, and can be specifically adjusted according to the actual crosstalk.

Exemplarily, the pixels may also be decomposed with a column as a unit, the M left-sub odd group signal frames include pixel information of all the odd columns of the left-eye picture, and the N left-sub even group signal frames include pixel information of all the even columns of the left-eye picture; the X right-sub odd group signal frames include pixel information of all the odd columns of the right-eye picture, and the Y right-sub even group signal frames include pixel information of all the even columns of the right-eye picture.

In this case, the pixels of all the even columns in each frame of the left-sub odd group signal frames, the pixels of all the odd columns in each frame of the left-sub even group signal frames, the pixels of all the odd columns in each frame of the right-sub even group signal frames, and the pixels of all the even columns in each frame of the right-sub odd group signal frames all display random gray-scale values, which may be either the same or different, and can be specifically adjusted according to the actual crosstalk.

It should be noted that, each frame of the odd group signal frames in this embodiment may include the pixel information of a single odd row/column, and of course, the pixel information of a plurality of adjacent odd rows/columns may also form one frame of the odd group signal frames; likewise, each frame of the even group signal frames in this embodiment may include the pixel information of a single even row/column, and of course, the pixel information of a plurality of adjacent even rows/columns may also form one frame of the even group signal frames.

Further, an embodiment of the present invention further provides a 3D display device, which can implement the above 3D display method, the 3D display device comprising: a display module, configured to continuously display left-eye sub-pictures and then continuously display right-eye sub-pictures; or, configured to continuously display the right-eye sub-pictures and then continuously display the left-eye sub-pictures, wherein, the left-eye sub-pictures are obtained by decomposing a left-eye picture corresponding to one frame of picture, and the right-eye sub-pictures are obtained by decomposing a right-eye picture corresponding to the one frame of picture.

Exemplarily, the left-eye sub-pictures are obtained by decomposing the left-eye picture decomposed from one frame of picture into M left-sub odd group signal frames and N left-sub even group signal frames, that is, the continuously displayed left-eye sub-pictures correspond to the M left-sub odd group signal frames and the N left-sub even group signal frames continuously displayed; the right-eye sub-picture is obtained by decomposing the right-eye picture decomposed from the one frame of picture into X right-sub odd group signal frames and Y right-sub even group signal frames, that is, the continuously displayed right-eye sub-pictures correspond to the X right-sub odd group signal frames and the Y right-sub even group signal frames continuously displayed, wherein each of M, N, X and Y is an integer greater than 1.

Exemplarily, the 3D display device further comprises a decomposing module, configured to respectively decompose the left-eye picture and the right-eye picture corresponding to one frame of picture into the continuously displayed left-eye sub-pictures and the continuously displayed right-eye sub-pictures, the left-eye picture including pixel information of a left-eye perspective picture, and the right-eye picture including pixel information of a right-eye perspective picture.

In general, N and M may be equal; or X and Y may be equal; or M, N, X and Y may all be equal.

In order that the pictures form a continuous image in the human eyes, when the left-eye sub-pictures and the right-eye sub-pictures are displayed, a sum of display time of the left-eye sub-pictures may be no greater than vision persistence time of the human eyes; and a sum of display time of the right-eye sub-pictures may also be no greater than the vision persistence time of the human eyes.

In order to achieve a better anti-crosstalk effect, a transition picture may be inserted after the left-eye sub-pictures are continuously displayed and before the right-eye sub-pictures continue to be displayed; or the transition picture may be inserted after the right-eye sub-pictures are continuously displayed, and before the left-eye sub-pictures continue to be displayed.

Further, in a process of continuously displaying the left-eye sub-pictures, the transition picture may be inserted between each two frames of the left-sub odd group signal frames; and/or, the transition picture may be inserted between each two frames of the left-sub even group signal frames. Alternatively, in the process of continuously displaying the left-eye sub-pictures, the transition picture may be inserted between the last frame of the left-sub odd group signal frames and the first frame of the left-sub even group signal frames; or, the transition picture may be inserted between the last frame of the left-sub even group signal frames and the first frame of the left-sub odd group signal frames.

Likewise, in a process of continuously displaying the right-eye sub-pictures, the transition picture may be inserted between each two frames of the right-sub odd group signal frames; and/or the transition picture may be inserted between each two frames of the right-sub even group signal frames. Alternatively, in the process of continuously displaying the right-eye sub-pictures, the transition picture may be inserted between the last frame of the right-sub odd group signal frames and the first frame of the right-sub even group signal frames; or, the transition picture may be inserted between the last frame of the right-sub even group signal frames and the first frame of the right-sub odd group signal frames.

Exemplarily, for natural transition of the transition picture, which serves to prevent crosstalk, gray-scale values of all the pixels of the transition picture may be equal.

Both the pixels of the left-eye sub-picture and the pixels of the right-eye sub-picture display the same gray-scale value.

Exemplarily, the pixels may be decomposed with a row as a unit, and the M left-sub odd group signal frames include pixel information of all the odd rows of the left-eye perspective picture, and the N left-sub even group signal frames include pixel information of all the even rows of the left-eye perspective picture; the X right-sub odd group signal frames include pixel information of all the odd rows of the right-eye perspective picture, and the Y right-sub even group signal frames include pixel information of all the even rows of the right-eye perspective picture.

In this case, the pixels of all the even rows in each frame of the left-sub odd group signal frames, the pixels of all the odd rows in each frame of the left-sub even group signal frames, the pixels of all the even rows in each frame of the right-sub even group signal frames, and the pixels of all the odd rows in each frame of the right-sub odd group signal frames all display the same gray-scale value.

Alternatively, the pixels may also be decomposed with a column as a unit, the M left-sub odd group signal frames include pixel information of all the odd columns of the left-eye perspective picture, and the N left-sub even group signal frames include pixel information of all the even columns of the left-eye perspective picture; the X right-sub odd group signal frames include pixel information of all the odd columns of the right-eye perspective picture, and the Y right-sub even group signal frames include pixel information of all the even columns of the right-eye perspective picture.

In this case, the pixels of all the even columns in each frame of the left-sub odd group signal frames, the pixels of all the odd columns in each frame of the left-sub even group signal frames, the pixels of all the odd columns in each frame of the right-sub even group signal frames, and the pixels of all the even columns in each frame of the right-sub odd group signal frames all display random gray-scale values, which may be either the same or different, and can be specifically adjusted according to the actual crosstalk.

The 3D display device and the 3D display method according to embodiments of the present invention, by continuously displaying the left-eye sub-pictures and continuously displaying the right-eye sub-pictures, solve the problem of the 3D crosstalk when the left-eye perspective picture and the right-eye perspective picture alternate, and improves the 3D display effect.

In the 3D display method and the 3D display device provided by the embodiments of the present invention, the left-eye picture and the right-eye picture decomposed from one frame of picture are respectively decomposed into the continuously displayed left-eye sub-pictures and the continuously displayed right-eye sub-pictures; exemplarily, the left-eye picture is decomposed into M left-sub odd group signal frames and N left-sub even group signal frames, and the right-eye picture is decomposed into X right-sub odd group signal frames and Y right-sub even group signal frames, so that each frame of the sub-picture can only display partial picture information, which solves the 3D crosstalk problem when the left-eye perspective picture and the right-eye perspective picture alternate, and improves the 3D display effect.

The embodiment of the invention being thus described, it will be obvious that the same may be varied in many ways. Such variations are not to be regarded as a departure from the spirit and scope of the invention, and all such modifications as would be obvious to those skilled in the art are intended to be included within the scope of the following claims.

The present application claims priority of Chinese Patent Application No. 201310750330.8 filed on Dec. 30, 2013, the disclosure of which is incorporated herein by reference in its entirety as part of the present application.

1. A 3D display method, comprising:
decomposing one frame of picture into a left-eye picture and a right-eye picture, the left-eye picture including pixel information of a left-eye perspective picture, and the right-eye picture including pixel information of a right-eye perspective picture; and
decomposing the left-eye picture into continuously displayed left-eye sub-pictures, and decomposing the right-eye picture into continuously displayed right-eye sub-pictures.

2. The 3D display method according to claim 1, wherein, the continuously displayed left-eye sub-pictures are obtained by decomposing the left-eye picture into M left-sub odd group signal frames and N left-sub even group signal frames continuously displayed, the continuously displayed left-eye sub-pictures corresponding to the M left-sub odd group signal frames and the N left-sub even group signal frames continuously displayed; the continuously displayed right-eye sub-pictures are obtained by decomposing the right-eye picture into X right-sub odd group signal frames and Y right-sub even group signal frames, the continuously displayed right-eye sub-pictures corresponding to the X right-sub odd group signal frames and the Y right-sub even group signal frames continuously displayed, where M, N, X and Y are all integers greater than 1.

3. The 3D display method according to claim 2, wherein, N and M are equal; or X and Y are equal; or M, N, X and Y are all equal.

4. The 3D display method according to claim 1, wherein, a sum of display time of the left-eye sub-pictures is no greater than vision persistence time of human eyes; and a sum of display time of the right-eye sub-pictures is no greater than the vision persistence time of the human eyes.

5. The 3D display method according to claim 1, wherein, a transition picture is inserted after the left-eye sub-pictures are continuously displayed and before the right-eye sub-pictures continue to be displayed; or the transition picture is inserted after the right-eye sub-pictures are continuously displayed, and before the left-eye sub-pictures continue to be displayed.

6. The 3D display method according to claim 5, wherein, in a process of continuously displaying the left-eye sub-pictures, the transition picture is inserted between each two frames of the left-sub odd group signal frames; and/or, the transition picture is inserted between each two frames of the left-sub even group signal frames.

7. The 3D display method according to claim 5, wherein, in a process of continuously displaying the left-eye sub-pictures, the transition picture is inserted between the last frame of the left-sub odd group signal frames and the first frame of the left-sub even group signal frames; or, the transition picture is inserted between the last frame of the left-sub even group signal frames and the first frame of the left-sub odd group signal frames.

8. The 3D display method according to claim 5, wherein, in a process of continuously displaying the right-eye sub-pictures, the transition picture is inserted between each two frames of the right-sub odd group signal frames; and/or, the transition picture is inserted between each two frames of the right-sub even group signal frames.

9. The 3D display method according to claim 5, wherein, in a process of continuously displaying the right-eye sub-pictures, the transition picture is inserted between the last frame of the right-sub odd group signal frames and the first frame of the right-sub even group signal frames; or, the transition picture is inserted between the last frame of the right-sub even group signal frames and the first frame of the right-sub odd group signal frames.

10. The 3D display method according to claim 5, wherein gray-scale values of all the pixels of the transition picture are equal.

11. The 3D display method according to claim 2, wherein the M left-sub odd group signal frames comprise pixel information of all odd rows of the left-eye perspective picture, and the N left-sub even group signal frames comprise pixel information of all even rows of the left-eye perspective picture; the X right-sub odd group signal frames comprise pixel information of all odd rows of the right-eye perspective picture, and the Y right-sub even group signal frames comprise pixel information of all even rows of the right-eye perspective picture.

12. The 3D display method according to claim 11, wherein the pixels in all even rows of the left-sub odd group signal frames, the pixels in all odd rows of the left-sub even group signal frames, the pixels in all odd rows of the right-sub even group signal frames, and the pixels in all even rows of the right-sub odd group signal frames all have a same gray-scale value.

13. The 3D display method according to claim 2, the M left-sub odd group signal frames comprise pixel information of all odd columns of the left-eye perspective picture, and the N left-sub even group signal frames comprise pixel information of all even columns of the left-eye perspective picture; the X right-sub odd group signal frames comprise pixel information of all odd columns of the right-eye perspective picture, and the Y right-sub even group signal frames comprise pixel information of all even columns of the right-eye perspective picture.

14. The 3D display method according to claim 13, wherein, the pixels in all even columns of the left-sub odd group signal frames, the pixels in all odd columns of the left-sub even group signal frames, the pixels in all odd columns of the right-sub even group signal frames, and the pixels in all even columns of the right-sub odd group signal frames all have a same gray-scale value.

15. A 3D display device, comprising:
a display module, configured to continuously display left-eye sub-pictures, and then continuously display right-eye sub-pictures; or, configured to continuously display the right-eye sub-pictures, and then continuously display the left-eye sub-pictures,
wherein, the left-eye sub-pictures are obtained by decomposing a left-eye picture corresponding to one frame of picture, and the right-eye sub-pictures are obtained by decomposing a right-eye picture corresponding to the one frame of picture.

16. The 3D display device according to claim 15, wherein the continuously displayed left-eye sub-pictures are obtained by decomposing the left-eye picture into M left-sub odd group signal frames and N left-sub even group signal frames continuously displayed, the continuously displayed left-eye sub-pictures corresponding to the M left-sub odd group signal frames and the N left-sub even group signal frames continuously displayed; the continuously displayed right-eye sub-pictures are obtained by decomposing the right-eye picture into X right-sub odd group signal frames and Y right-sub even group signal frames, the continuously displayed right-eye sub-pictures corresponding to the X right-sub odd group signal frames and the Y right-sub even group signal frames continuously displayed, where M, N, X and Y are all integers greater than 1.

17. The 3D display device according to claim 15, further comprising: a decomposing module, configured to decompose the one frame of picture into the continuously displayed left-eye sub-pictures and the continuously displayed right-eye sub-pictures, the left-eye picture including pixel information of a left-eye perspective picture, and the right-eye picture including pixel information of a right-eye perspective picture.

18. The 3D display device according to claim 16, wherein, N and M are equal; or X and Y are equal; or M, N, X and Y are all equal.

19. The 3D display device according to claim 15, wherein, a sum of display time of the left-eye sub-pictures is no greater than vision persistence time of human eyes; and a sum of display time of the right-eye sub-pictures is no greater than the vision persistence time of the human eyes.

20. The 3D display device according to claim 15, wherein a transition picture is inserted after the left-eye sub-pictures are continuously displayed and before the right-eye sub-pictures continue to be displayed; or the transition picture is inserted after the right-eye sub-pictures are continuously displayed, and before the left-eye sub-pictures continue to be displayed.
